(19) United States
(12) Patent Application Publication
(10) Pub. No.: US 2014/0055890 A1
(43) Pub. Date: Feb. 27, 2014

(54) CIRCUIT ASSEMBLY FOR AN ALTERNATING CURRENT CONTACTOR, MOTOR PROTECTION RELAY AND METHOD FOR PRODUCING A POWER SUPPLY UNIT

(71) Applicant: Wolfgang Meid, Muelheim-Kaerlich (DE)

(72) Inventor: Wolfgang Meid, Muelheim-Kaerlich (DE)

(73) Assignee: EATON ELECTRICAL IP GMBH & CO. KG, Schoenefeld (DE)

(21) Appl. No.: 14/112,038

(22) PCT Filed: Apr. 17, 2012
(86) PCT No.: PCT/EP2012/057023

§ 371 Date: Nov. 15, 2013

(30) Foreign Application Priority Data
Apr. 19, 2011 (EP) 11163031.5

(51) Int. Cl. H01H 50/44; H02H 7/08; H01H 51/30

(52) U.S. Cl. CPC H01H 50/44; H01H 51/30; H02H 7/08
USPC 361/23; 335/99

(57) ABSTRACT

A circuit assembly for an alternating current contactor has an excitation coil, wherein the excitation coil has at least one first winding for generating a pick-up and/or release current. A method for producing a power supply unit of an electric load includes using an excitation coil of an alternating current contactor having at least one first winding for generating a pick-up and/or release current.

### CROSS-REFERENCE TO RELATED APPLICATIONS

This application is a U.S. National Phase application under 35 U.S.C. §371 of International Application No. PCT/EP2012/057023, filed on Apr. 17, 2012, and claims benefit to European Patent Application No. EP 11163031.5, filed on Apr. 19, 2011. The International Application was published in German on Oct. 26, 2012, as WO 2012/143361 A1 under PCT Article 21(2).

### FIELD

The invention concerns a circuit arrangement for an AC contactor with an excitation coil, wherein the excitation coil has at least a first winding for generating a pick-up and/or discharge excitation, a motor protection relay having such a circuit arrangement, and a method for producing a voltage supply for an electrical load, wherein a excitation coil of an AC contactor with at least a first winding for generating a pick-up and/or discharge excitation is used.

### BACKGROUND

Motor protection relays, also called overload relays, represent a possible application of a circuit arrangement as a current overload protection system, which monitor the temperature of the motor winding indirectly via the current flowing in the supply line current. A motor protection relay provides proven and cost-efficient protection for an electric motor from destruction by non-start, overload or phase failure.

An electronic motor protection system is described, for example, in EP 1 050 943 A2. A disadvantage of such systems is that the electronics are powered by a separate power supply, usually through a transformer, with an operating voltage, which requires considerable space and considerably increases the cost of the otherwise simple safety device. Plant construction requires a compact design of the protection system, in particular as a pluggable module, which with a separate transformer would only be possible with considerable design effort.

### SUMMARY

In an embodiment, the present invention provides a circuit arrangement for an AC contactor, the circuit arrangement comprising: an excitation coil, wherein the excitation coil includes a first winding configured to generate at least one of a pick-up excitation and a discharge excitation, the excitation coil includes a second winding configured as voltage supply for an electrical load.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a schematic diagram of an inventive circuit arrangement; and

FIG. 2 the circuit arrangement of FIG. 1 in an advantageous development.

### DETAILED DESCRIPTION

The invention provides a circuit arrangement for an AC contactor with an excitation coil in such a manner that a compact construction of the circuit arrangement is achieved along with cost savings.

The inventive circuit arrangement for an AC contactor includes an excitation coil, wherein the excitation coil has at least a first winding for generating a pick-up and/or discharge excitation. Under an AC contactor according to the invention is a relay for connecting higher power, for example, in power engineering, wherein the control circuit is operated with alternating voltage. The current and voltage in the load circuit can be larger than the excitation coil by a multiple. Contactors generally have a tie rod, for whose actuation a somewhat higher power is required than for a hinged armature in a relay. Contactors may have a plurality of identical switching contacts, which are required, for example, for connecting three-phase loads.

The invention provides for the excitation coil having at least a second winding, said second winding being designed as a voltage supply for an electrical load. One advantage is that the voltage supply is available at the exact time when the control current flows through the first winding of the excitation coil. For this purpose, the first winding can in particular be connected through a switch to an AC power source. Along with the first winding, the second winding of the excitation coil forms a transformer on the common core, so that the load is supplied with a corresponding induced alternating current. For this purpose, the first winding is electrically isolated from the second winding. The person skilled in the art will hereby be aware of the effects of number of turns and wire size of the first and second winding on the parameters of the induced current. The second winding is in particular arranged in parallel to the first winding, wherein they are arranged next to one another or over one another.

The electrical load can advantageously be any load that is working when the control circuit is activated. The load is thus preferably an electronic circuit that requires a voltage supply, while the first coil is connected to an AC power source. According to a preferred embodiment, the electrical load has an electronic circuit, said electronic circuit being arranged to interrupt a connection of the first winding with an AC power source. This occurs particularly under previously defined conditions, which are dependent on the characteristics of the electronics.

An interruption is conceivable after a certain time or at defined limits are exceeded in a measured parameter. By interrupting the connection of the first winding to the AC power source, say, by activating an break contact in the control circuit, the excitation circuit, or control circuit, is disconnected and the AC contactor switches off the load circuit. Simultaneously, the voltage supply of the electrical load is disconnected. In particular, the electrical load is an electronic measurement system of a motor protection relay. The usual term motor protection relay according to the invention is understood to mean a system for overload protection of an electric motor, not the individual relay or contactor. Once parameters that indicate an overload of the motor are detected by the measurement electronics system, the measurement electronics system can directly and advantageously switch off the AC contactor, so that the motor is disconnected. The measurement electronics system is switched off at the same time, since there is no longer any voltage supply through the second winding, until the motor is subsequently switched on by external actuation.

Another embodiment provides thus a motor protection relay with a circuit arrangement according to the invention, as described above, wherein the AC contactor is provided for connecting a motor and wherein the electrical load is an electronic system for monitoring the motor.

Another embodiment provides a method for producing a voltage supply for an electrical load, wherein an excitation coil of an AC contactor is used with at least a first winding for generating a pick-up and/or discharge excitation, wherein at least one second winding of the excitation coil is used for voltage supply to the electrical load. The first winding is connected via a switch with an AC power source. Preferred is a connection of the first winding to the AC power source separated by the electrical load, ideally by means of an break contact in the control circuit, and also preferably when achieving defined parameters.

The invention will be explained with reference to an exemplary embodiment. The representation is only an example and does not limit the general concept of the invention. The designs apply both to the circuit arrangement according to the invention as well as the method.

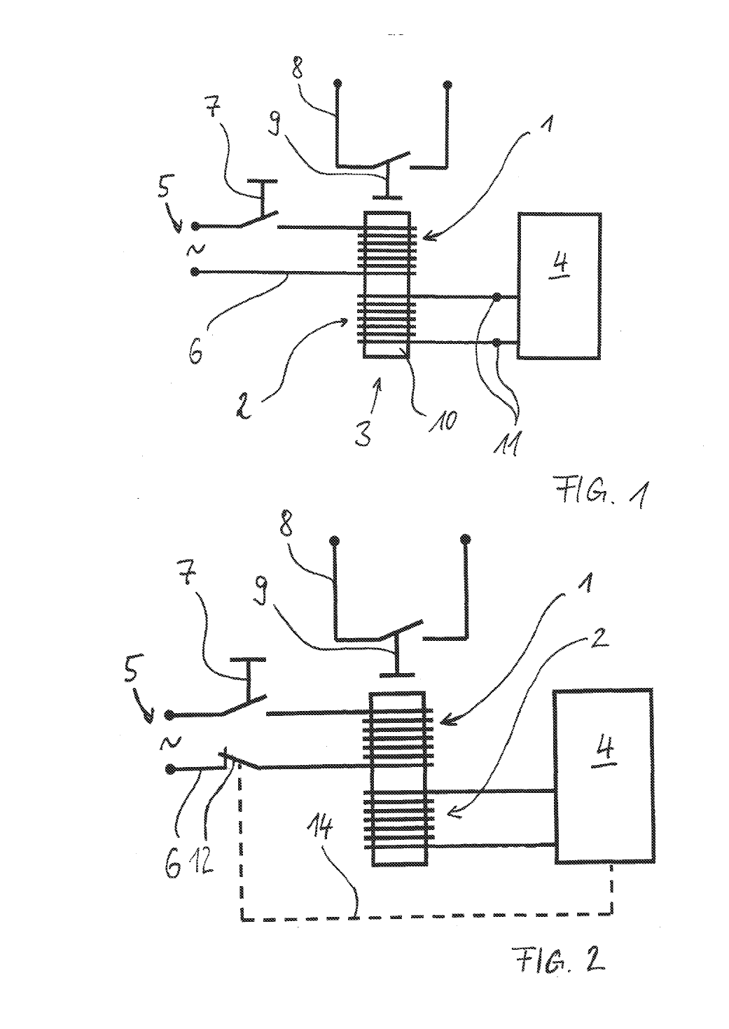

FIG. 1 shows an inventive circuit arrangement for an AC contactor with an excitation coil 3, wherein the excitation coil 3 has at least a first winding 1 for generating a pick-up and/or discharge excitation. A control circuit 6 is operated with an alternating voltage 5. A load circuit 8 is shown only as indicative. When switching on the alternating voltage in the control circuit 6 through the switch 7, the first coil 1 along with the core 10 generates a magnetic field, which attracts a tie rod 9 that in turn closes the load current circuit 8. The invention is characterized in that the excitation coil 3 has at least one second coil 2, wherein the second winding 2 is designed as voltage supply for an electrical load 4. The voltage supply is available at the terminals 11 of the second coil 2 exactly 30 when the control current flows through the first winding 1 of the excitation coil 3. The second winding 2 of the excitation coil 3 forms a transformer along with the common coil core 10, so that the load 4 is supplied with a corresponding induced current. The first winding 1 is distinctly electrically isolated from the second winding 2.

The circuit arrangement in accordance with FIG. 2 differs from the circuit arrangement described in the context of FIG. 1 only in that the electrical load 4 is provided for actuating a break contact 12 via a connection 14. The connection of the first coil 1 is thus disconnected from the AC power source 5, with the control circuit 6 thus being interrupted. Subsequently, the tie rod 9 opens the load circuit 8 by spring-loading. Simultaneously, no current flow is induced in the second coil 2, so that the power supply of the electrical load 4 is also disconnected.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### REFERENCE LIST

1 First winding

2 Second winding

3 Excitation coil

4 Load

5 AC power source

6 Control circuit

7 Switch

8 Load circuit

9 Tie road

10 Core

11 Connectors

12 Break contactor

14 Connection

1. A circuit arrangement for an AC contactor, the circuit arrangement comprising:
an excitation coil,
wherein the excitation coil includes a first winding configured to generate at least one of a pick-up excitation or a discharge excitation, and
the excitation coil includes a second winding configured as voltage supply for an electrical load.

2. The circuit arrangement of claim 1, wherein the first coil is configured such that it can be connected with an AC power source.

3. The circuit arrangement of claim 1, wherein the first winding is electrically separated from the second winding.

4. The circuit arrangement of claim 1, wherein the electrical load includes an electronic circuit,
a voltage supply being provided for the electronic circuit, so long as the first winding is connected to an AC power source.

5. The circuit arrangement of claim 1, wherein the electrical load includes an electronic circuit,
configured to interrupt a connection of the first winding with an AC power source.

6. The circuit arrangement of claim 1, wherein the electrical load is a measurement electronic system of a motor protection relay.

7. A motor protection relay, comprising:
the circuit arrangement of claim 1; and
an AC contactor configured to drive a motor,
wherein the electrical load of the circuit arrangement is an electronic system for monitoring the motor.

8. A method for producing a voltage supply for an electrical load, the method comprising:
generating at least one of a pick-up excitation and a discharge excitation with a first winding of an excitation coil of an AC contactor, and
supplying a voltage to the electrical load with at least one second winding on the excitation coil.

9. The method of claim 8, further comprising:
connecting the first winding with an AC power source.

10. The method of claim 8, further comprising:
separating a connection between the first winding and an AC power source by the electrical load.

11. The circuit arrangement of claim 1, wherein the first winding is configured to generate a pick-up excitation.

12. The circuit arrangement of claim 1, wherein the first winding is configured to generate a discharge excitation.

13. The circuit arrangement of claim 1, wherein the first winding is configured to generate a pick-up excitation and a discharge excitation.
